(19) United States
(12) Patent Application Publication
(10) Pub. No.: US 2004/0141329 A1
(43) Pub. Date: Jul. 22, 2004

(54) Lighting system for aircraft cabins

(76) Inventors: Walter Fleischmann, Allersberg (DE); Markus Stoffler, Furth (DE); Dirk-Achim Schevardo, Kainsbach (DE)

Correspondence Address: SCULLY SCOTT MURPHY & PRESSER, PC, 400 GARDEN CITY PLAZA, GARDEN CITY, NY, 11530

(21) Appl. No.: 10/731,344

(22) Filed: Dec. 9, 2003

(30) Foreign Application Priority Data
Jan. 20, 2003 (DE) 103 02 332.4

(51) Int. Cl. F21V 1/20; B64F 1/20

(52) U.S. Cl. 362/470; 362/471; 362/543; 362/545; 362/800

(57) ABSTRACT

Proposed is a lighting system for aircraft cabins comprising light emitting diodes (8.1-8.5, 9.1-9.5, 10.1-10.5, 11.1-11.5) which are arranged at or in a cabin wall means, in which there are provided a plurality of lighting units (4-7) which each have at least one light emitting diode (8.1-8.5, 9.1-9.5, 10.1-10.5, 11.1-11.5) and are connected to an output (2.1-2.3) of a control device (1), wherein actuation of the lighting units (4-7) is effected independently of each other by way of the control device (1).

The invention concerns a lighting system for aircraft cabins with light emitting diodes which are arranged at or in a cabin wall.

Such a lighting system is known from DE 198 43 330 A1. Disclosed therein is emergency lighting for aircraft cabins, in which light emitting diodes are arranged in the cabin ceiling above a cabin gangway. That lighting arrangement makes it possible for a part of the cabin such as for example the cabin gangway to be illuminated in such a way that, if the other cabin lighting fails in an emergency situation the passengers can still find their way around and can reach the exits.

Based on the state of the art referred to, the object of the invention is further to develop a lighting system of the general kind set forth, in such a way that it can be used in a more versatile fashion.

That object is attained by a lighting system having the features of claim 1 and a use of that lighting system as set forth in claim 9. Advantageous configurations and developments of the invention are set forth in the appendant claims.

The invention is characterised in that the light emitting diodes are associated with a plurality of lighting units which are connected to a control device and are actuated independently of each other by way of the control device. In that way the lighting system can be adapted to the most widely varying lighting purposes in a flexible and versatile fashion.

In a preferred embodiment the control device has a plurality of outputs, wherein various lighting units to be actuated are connected to different outputs. Lighting units which are to be actuated at the same time can be connected to the same output of the control device, wherein the electrical circuitry is preferably parallel.

In addition a preferred configuration of the invention provides that the lighting units include a regulating module which holds the current through the light emitting diodes at a constant value. The lighting units preferably have a plurality of and in particular five light emitting diodes which are electrically connected in series. The light emitting diodes are preferably actuated by means of pulse width modulation.

In a development of the invention it can be provided that the light emitting diodes are arranged at or in the cabin wall in such a way that signs or images can be displayed. In addition the light emitting diodes can be actuated in such a way that effects, preferably flashing, twinkling, colour change or moving light can be represented.

The lighting system can be used as an effect lighting arrangement, preferably for simulating a starry sky, for displaying items of information or for marking localities. In that respect actuation of the lighting arrangement can be coupled to events in the aircraft.

An embodiment of the invention will now be described in greater detail with reference to the drawing in which:

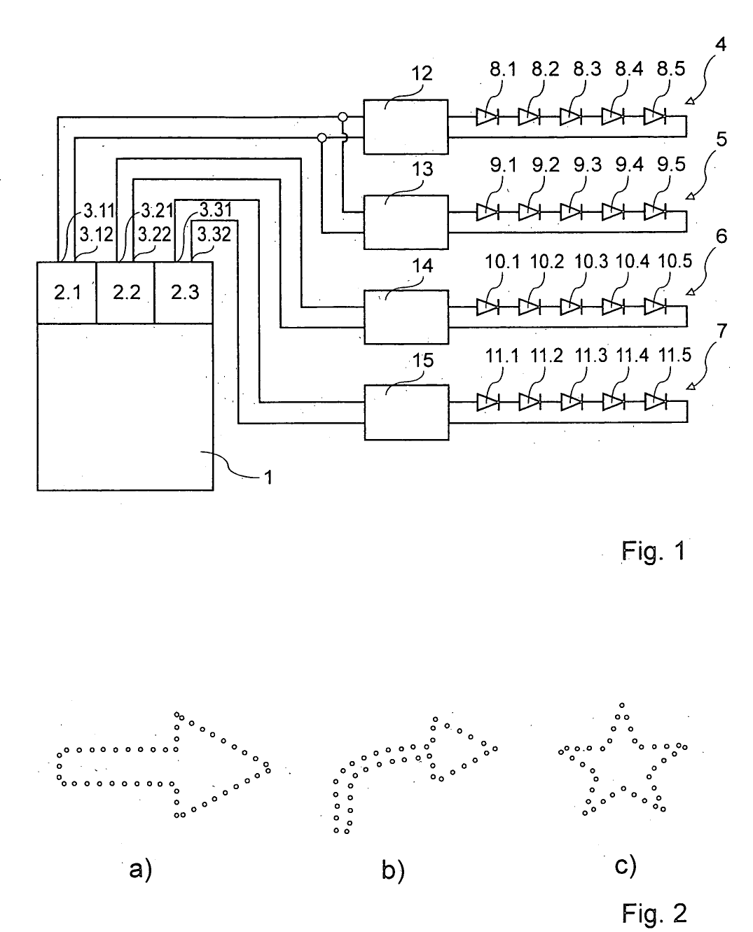

FIG. 1 shows a block circuit diagram of a lighting system, and

FIGS. 2a-2c show various symbols which can be displayed with the lighting system.

A control device 1 has three channels 2.1, 2.2 and 2.3 which each have a two-pole output 3.11 and 3.12, 3.21 and 3.22, and 3.31 and 3.32. Two lighting units 4 and 5 are connected electrically in parallel to the poles 3.11 and 3.12 of the first channel 2.1 of the control device 1. A lighting unit 6 is connected to the poles 3.21 and 3.22 of the second channel 2.2 of the control device 1 and a lighting unit 7 is connected to the poles 3.31 and 3.32 of the third channel 2.3 of the control device 1. Each of the lighting units 4-7 has five light emitting diodes 8.1-8.5, 9.1-9.5, 10.1-10.5 and 11.1-11.5 which are each respectively connected electrically in series and connected to a regulating module 12-15. The regulating modules 12-15 regulate the current through the light emitting diodes 8.1-8.5, 9.1-9.5, 10.1-10.5 and 11.1-11.5 to 14 mA in each case.

It will be appreciated now that markedly more lighting units can also be connected to the channels 2.1-2.3 of the control device, in which case the lighting units connected to a channel 2.1-2.3 of the control device 1 are respectively connected in mutually parallel relationship. That lighting system now makes it possible to simulate a starry sky for example when the aircraft cabin is darkened. In that case the lighting units 4 and 5 connected to the channel 2.1 are actuated in such a way that they light with a low level of brightness and form background stars in the starry sky simulation. The light emitting diodes 10.1-10.5 connected to the channel 2.2 are arranged in the cabin wall in such a way that they form star information such as for example star images and are actuated by the control device 1 with a somewhat higher level of brightness. The light emitting diodes 11.1-11.5 of the lighting unit 7, which are connected to the channel 2.3 of the control device 1, are actuated with fluctuating levels of brightness so that they simulate twinkling stars.

As shown in FIGS. 2a-c the light emitting diodes of the lighting units 4-7 can also be arranged in the cabin wall structure, that is to say in the ceiling of the cabin, the wall of the cabin or also the baggage storage covering (the so-called hat rack) in such a way that they represent the most widely varying signs—such as for example a straight arrow (FIG. 2a), a curved arrow (FIG. 2b) or a star (FIG. 2c). As it is possible in the meantime to obtain light emitting diodes of all primary colours with a sufficient level of brightness, it is also possible to form logos, for example of the respective airline, or also entire images, with the light emitting diodes, by virtue of a suitable arrangement and actuation of the light emitting diodes. The shape of the light exit of the individual light emitting diodes can in that case be round, rectangular, square or also triangular.

By means of common pulse width modulation it is possible for the light emitting diodes of the various colours to be dimmed in various levels of brightness, they can flash (switched on/off) or twinkle (lighter/darker) or it is also possible with them to provide a travelling light effect with which for example the way to the exit or also to the emergency exit (possibly in different colours) can be marked.

Thus the invention makes it possible to achieve lighting which can be actuated and used in a highly variable fashion to achieve the most widely differing effects at the cabin wall or in the aircraft cabin. It will be appreciated that pure lighting of the aircraft cabin with white or also coloured light is also a possibility. In addition actuation of the lighting units 4-7 can also be coupled to events in the aircraft such as for example an announcement, the distribution of meals or drinks or also preparation for landing.

1. A lighting system for aircraft cabins comprising light emitting diodes (8.1-8.5, 9.1-9.5, 10.1-10.5, 11.1-11.5) which are arranged at or in a cabin wall means, characterised in that there are provided a plurality of lighting units (4-7) which each have at least one light emitting diode (8.1-8.5, 9.1-9.5, 10.1-10.5, 11.1-11.5) and are connected to an output (2.1-2.3) of a control device (1), wherein actuation of the lighting units (4-7) is effected independently of each other by way of the control device (1).

2. A lighting system according to claim 1 characterised in that the control device (1) has a plurality of outputs (2.1-2.3), wherein lighting units (4-7) to be actuated in various ways are connected to different outputs (2.1-2.3).

3. A lighting system according to claim 1 or claim 2 characterised in that lighting units (4-7) which are to be actuated at the same time are connected to an output (2.1-2.3) of the control device (1), wherein the lighting units (4-7) are preferably electrically connected in parallel with each other.

4. A lighting system according to one of claims 1 to 3 characterised in that the lighting units (4-7) include a regulating module (12-15) which holds the current through the light emitting diode or diodes (8.1-8.5, 9.1-9.5, 10.1-10.5, 11.1-11.5) at a constant value.

5. A lighting system according to one of the preceding claims characterised in that the lighting units (4-7) have a plurality of and preferably five light emitting diodes (8.1-8.5, 9.1-9.5, 10.1-10.5, 11.1-11.5) which are electrically connected in series.

6. A lighting system according to one of the preceding claims characterised in that the light emitting diodes (8.1-8.5, 9.1-9.5, 10.1-10.5, 11.1-11.5) are actuable by means of pulse width modulation.

7. A lighting system according to one of the preceding claims characterised in that the light emitting diodes (8.1-8.5, 9.1-9.5, 10.1-10.5, 11.1-11.5) are arranged at or in the cabin wall in such a way that signs or images can be displayed.

8. A lighting system according to one of the preceding claims characterised in that the light emitting diodes (8.1-8.5, 9.1-9.5, 10.1-10.5, 11.1-11.5) are actuable in such a way that effects, preferably flashing, twinkling, colour change or moving light can be represented.

9. Use of the lighting system according to one of the preceding claims as effect lighting, preferably for stimulating a starry sky, for displaying information or for marking localities.

10. Use according to claim 9 characterised in that actuation of the lighting is effected coupled to events in the aircraft.
